(19) United States
(12) Patent Application Publication
(10) Pub. No.: US 2011/0174412 A1
(43) Pub. Date: Jul. 21, 2011

(54) TUBULAR BODY AND EXHAUST SYSTEM

(76) Inventors: Rolf JEBASINSKI, Filderstadt (DE); Jorg Oesterle, Laichingen (DE); Matthias Grün, Altbach (DE); Georg Wirth, Kirchheim/Teck (DE)

(21) Appl. No.: 13/009,476

(22) Filed: Jan. 19, 2011

(30) Foreign Application Priority Data
Jan. 20, 2010 (DE) 10 2010 004 960.3

(51) Int. Cl. F16L 9/14

(52) U.S. Cl. 138/145

(57) ABSTRACT

An exhaust gas-carrying tubular body (1) is provided for an exhaust system (2) of an internal combustion engine, especially of a motor vehicle. The tubular body (1) is provided on its inside (5) facing the exhaust gas and/or on its outside (6) facing away from the exhaust gas with a coating (7, 8), which is formed of a composite ceramic based on nanoparticles.

### CROSS REFERENCE TO RELATED APPLICATIONS

This application claims the benefit of priority under 35 U.S.C. §119 of German Patent Application DE 10 2010 004 960.3 filed Jan. 20, 2010, the entire contents of which are incorporated herein by reference.

### FIELD OF THE INVENTION

The present invention pertains to an exhaust gas-carrying tubular body for an exhaust system of an internal combustion engine, especially of a motor vehicle. The present invention pertains, moreover, to an exhaust system with at least one such tubular body.

### BACKGROUND OF THE INVENTION

It may be necessary within an exhaust system for various reasons to embody a heat insulation towards the outside or towards the inside. On the one hand, it may be necessary to protect an environment of the exhaust system from the high temperatures of the exhaust gases being transported in the exhaust system. The exhaust system may be thermally insulated for this purpose towards the outside at least in some areas. On the other hand, it may be desirable to maintain the high temperature level of the exhaust gas being transported in the exhaust system, for example, in order to make it possible to reach a predetermined operating temperature or regeneration temperature for certain exhaust gas-treating means as rapidly as possible or in order to maintain a certain operating temperature even in operating states of the internal combustion engine in which a comparatively small amount of heat is removed via the exhaust gas. The exhaust system may be thermally insulated for this purpose towards the inside at least in some areas. For example, an oxidation-type catalytic converter, such as an SCR catalytic converter or an NOx storage catalyst, requires a predetermined operating temperature in order to carry out the desired exhaust gas-cleaning function with sufficient effectiveness. Furthermore, for example, a particle filter requires a certain regeneration temperature in order to make it possible to carry out a regeneration process.

To thermally insulate, for example, a tubular body within an exhaust system, it is possible, in principle, to design the tubular body as a double-walled tubular body, such that an air gap insulation is embodied within its wall. The drawback of this is that such a double-walled design requires, on the one hand, a comparatively large installation space and, on the other hand, it increases the weight of the component. If an attempt is made at applying an insulation layer to the tubular body on the outside, there is additionally a problem that the exhaust system is exposed to great temperature variations, so that even small deviations in the coefficients of thermal expansion between the respective tubular body and the respective coating compromise the service life of such a coating.

### SUMMARY OF THE INVENTION

The present invention pertains to the object of proposing an improved embodiment for a tubular body of the type mentioned in the introduction or for an exhaust system equipped therewith, which embodiment is characterized especially by the need for a small installation space as well as by low weight. Furthermore, comparatively good service life shall be achieved.

According to the invention, an exhaust gas-carrying tubular body is provided as well as an exhaust system of a motor vehicle internal combustion engine. The system comprises a motor vehicle with at least one tubular body for an exhaust system of an internal combustion engine. The tubular body comprises a tube wall forming the tubular body, the tube wall having an inner surface provided on a tubular body inside facing the exhaust gas and an outer surface provided on a tubular body outside facing away from the exhaust gas. A coating is provided on one of the inner surface and the outer surface. The coating consists of a composite ceramic based on nanoparticles.

The present invention is based on the general idea of coating the tubular body with a composite ceramic, which is based on nanoparticles. Such a coating may be embodied especially as a heat-insulating coating. For example, its emissivity may be ≦0.5 at least in a predetermined temperature range. Provisions may be made for coating the tubular body with the coating consisting of composite ceramic based on nanoparticles exclusively on an inside facing the exhaust gas. As a result, the radiant heat transmission from the exhaust gas to the tubular body can be significantly reduced in case of a corresponding emissivity. It is possible, as an alternative, to provide the tubular body with the coating consisting of composite ceramic based on nanoparticles exclusively on an outside facing away from the exhaust gas. The heat transmission from the tubular body into the environment, i.e., especially the heat radiation, is significantly reduced hereby. Furthermore, it is also possible to provide the tubular body with a coating consisting of composite ceramic based on nanoparticles both on its inside and on its outside in order to thus reduce, on the one hand, the heat transmission from the exhaust gas to the tubular body and, on the other hand, the heat transmission from the tubular body to the environment.

A composite ceramic usually consists of a composition of various ceramic materials, which are bonded together, for example, by a sintering operation. The individual ceramic materials may be present for this in the form of particles, which will then form together the composite ceramic. It is also possible to bond ceramic particles in a ceramic matrix. In a composite ceramic based on nanoparticles, the particles used to prepare the composite ceramic have a particle size in the nanometer range. Single-digit to three-digit nanometer values are possible.

Various parameters of the composite ceramic prepared on the basis of nanoparticles can be varied in a specific manner by selecting and composing the nanoparticles used. For example, it is thus possible to set the coefficient of thermal expansion of the coating such that it is quasi equal to the coefficient of thermal expansion of the tubular body. An especially intensive connection with long-term stability can be achieved as a result between the coating and the tubular body for the entire thermal range of the use of the tubular body or of the exhaust system. Furthermore, heat emission coefficients, so-called emissivities, can be set comparatively precisely. It is possible as a result, in particular, to significantly reduce the heat radiation to the outside. Another special advantage of such coatings is that it is sufficient to apply these as a comparatively thin layer to the tubular body to achieve the desired heat insulating effect. Such a coating correspondingly requires hardly any installation space and does not lead, moreover, to any significant increase in the weight of the tubular body.

For example, the respective coating may be designed such that it reaches an emissivity of about 0.2 in the infrared range. Contrary to this, an uncoated metal body has an emissivity of about 0.9. In other words, a drastic heat radiation can be achieved by means of the coating.

Especially advantageous is an embodiment in which the respective coating is thinner in terms of its layer thickness than a wall thickness of the tubular body. The coatings can be prepared, for example, in a range of 1/100 to 1/10 of the wall thickness of the tubular body. A typical wall thickness for a tubular body of an exhaust system equals, for example, 1.5 mm. The coatings can be made, by contrast, considerably thinner, for example, with a coating thickness of 0.015 mm to 0.15 mm. Therefore, this causes hardly any increase in the wall thickness of the tubular body.

If both the outside and the inside are provided with such a coating in the tubular body, provisions may be made according to an advantageous embodiment to embody or design the inner coating applied to the inside differently in respect to at least one parameter from the outer coating applied on the outside. Suitable parameters are, for example, the porosity of the coating, surface roughness of the coating, layer thickness, coefficient of thermal expansion, heat emission coefficient, modulus of elasticity, tensile strength, and compressive strength.

In addition or as an alternative, provisions may be made to embody the respective coating in its thickness direction and/or in the longitudinal direction of the tubular body and/or in the circumferential direction of the tubular body such that at least one parameter will vary. For example, it may be advantageous in bent tubular bodies to embody the respective coating differently in the outer arc than in the inner arc.

Another embodiment, in which the respective coating is provided with a temperature-dependent heat emission coefficient, may be especially advantageous. For example, the tubular body can better adapt as a result in respect to its coatings to a predetermined operating state or operating temperature range of the exhaust system.

Provisions may be made, for example, for making the heat emission coefficient lower below a first temperature than above a second temperature, which is either equal to the first temperature or higher than the first temperature. For example, it is possible as a result to maintain a predetermined minimum temperature or operating temperature. For example, as long as the temperature of the tubular body is below a predetermined temperature limit of, e.g., 600° C., a small heat transmission as well as a small heat radiation may be desirable in order to maintain a downstream (emission-relevant) component, e.g., an SCR catalytic converter, at its operating temperature. Furthermore, an overheating protection can be achieved by the proposed design because, for example, the largest possible amount of heat flows off, for example, a large amount of heat enters with the exhaust gas, for example, beginning from a predetermined other temperature limit of, e.g., 700° C. This is achieved, for example, by an emissivity that varies with the temperature, such that it increases with rising temperature.

The respective coating may have, in principle, essentially the same coefficient of thermal expansion as the tubular body. This leads to an especially high long-term stability as well as to constant properties over the entire temperature range.

An alternative is an embodiment in which the respective coating specifically has a lower coefficient of thermal expansion than the tubular body. The respective coating is provided with a microstructure in this embodiment, such that the respective coating comprises a plurality of individual coating sections, which are each firmly connected to the tubular body, but are mobile relative to one another with the thermal expansion of the tubular body. Such a microstructure can be embodied, for example, by surface grooves or by cracks in the coating. In conjunction with the different thermal expansion of the coating, at least one temperature-dependent parameter can be embodied by means of such a microstructure. For example, the above-mentioned grooves or cracks are comparatively small or closed at low temperatures, as a result of which the respective coating has an increased effectiveness in terms of heat insulation. The individual coating sections move apart from each other at higher temperature because of the expansion of the tubular body, as a result of which said grooves or cracks become larger. The insulating properties of the coating become worse as a consequence. In other words, the heat insulation decreases with rising temperature, which increases the release of heat, and an overheating protection effect can thus be achieved as well.

It is apparent that the above-mentioned features, which will also be explained below, can be applied not only in the particular combination indicated, but in other combinations or alone as well, without going beyond the scope of the present invention.

Preferred exemplary embodiments of the present invention are shown in the drawings and will be explained in more detail in the following description, where identical reference numbers designate identical or similar or functionally identical components. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a cross sectional view through a tubular body;

FIG. 2 is a longitudinal sectional view of the tubular body from FIG. 1;

FIG. 3 is a cross sectional view of the tubular body as in FIG. 1, but according to another embodiment;

FIG. 4 is a longitudinal sectional view of the tubular body from FIG. 3; and

FIG. 5 is a side view of a partial area of the tubular body from FIGS. 3 and 4.

### DESCRIPTION OF THE PREFERRED EMBODIMENTS

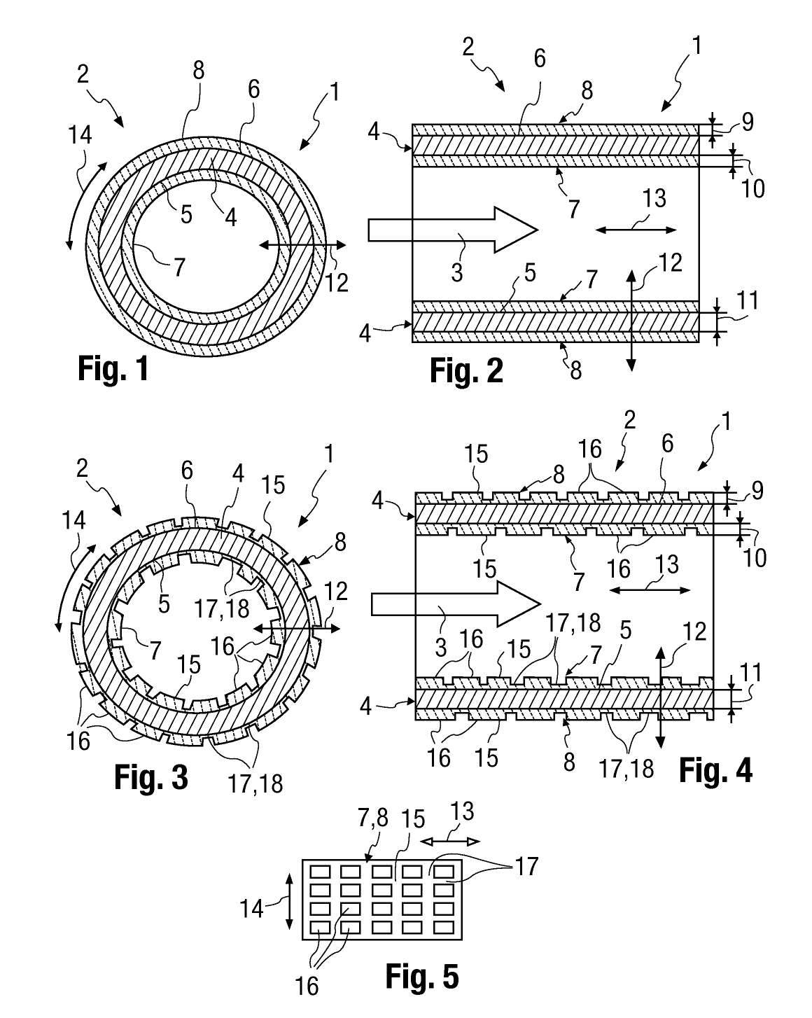

Referring to the drawings in particular, FIGS. 1 through 4 show a part of a tubular body 1 in the cross section and in a longitudinal section, respectively. The tubular body 1 preferably forms a component of an exhaust system 2, which is otherwise not shown, so that the exhaust system 2 has at least one such a tubular body 1. It is clear that the exhaust system 2 may also have two or more such tubular bodies 1.

The exhaust system 2 is used to remove exhaust gas of an internal combustion engine, which may be arranged especially in a motor vehicle. The tubular body 1 is correspondingly likewise used to carry exhaust gas. A corresponding exhaust gas flow is indicated by an arrow in FIGS. 2 and 4 and is designated by 3.

The tubular body 1 is embodied with a round cross section in the example shown in FIGS. 1 through 4. It is clear that other cross sections may, in principle, be provided as well. These may be other round cross sections or any designed cross-sectional geometries.

The tubular body 1 has a wall 4, whose inner surface forms an inside 5 of the tubular body 1 and whose outer surface forms an outside 6 of the tubular body 1. The inside 5 faces the exhaust gas, while the outside 6 faces away from the exhaust gas.

In the embodiments being shown here, the tubular body 1 carries on its inside 5 a coating 7, which will hereinafter also be called inner coating 7. In addition, the tubular body 1 carries on its outside 6 a coating 8, which will hereinafter also be called outer coating 8. Provisions may be made in a first alternative embodiment of the tubular body 1 for applying such a coating 7 on the inside 5 only. Provisions may be made in a second alternative embodiment of the tubular body 1 to provide such a coating 8 on the outside 6 only. Regardless of whether only the inner coating 7 or only the outer coating 8 is present or whether both coatings 7, 8 are present, the respective coating 7, 8 consists of a composite ceramic based on nanoparticles. In other words, the respective coating 7, 8 is prepared by means of ceramic particles, whose particle size is in the nanometer range. Provisions may be made, in particular, for bonding ceramic particles in a ceramic matrix in order to form the composite ceramic. Such a composite ceramic is preferably prepared by means of a sintering operation. For example, the respective surface of the wall 4 may be powder-coated, in which the powder coating is subsequently sintered. Other manufacturing processes or coating processes, e.g., spray coating, are, in principle, conceivable as well.

The respective coating 7, 8 preferably has a respective layer thickness 9 and 10 that is smaller than a wall thickness 11 of the wall 4 of the tubular body 1. The layer thickness 9, is maximally half the wall thickness 11 in the example. However, the coatings 7, 8 are preferably markedly thinner than the wall 4. In particular, wall 4 is at least 10 times thicker than the respective coating 7, 8. The coatings 7, 8 may be preferably prepared such that their layer thickness 9, 10 is in a range of 1/100 to 1/10 of the wall thickness 11 of the tubular body 1. Contrary to this, the wall thickness 11 is usually about 1 mm and is in a range of 0.5 mm to 2.5 mm. If, as in the embodiments being shown here, both sides 5, 6 are coated, provisions may be made according to a preferred embodiment for making the inner coating 7 and the outer coating 8 different in terms of at least one parameter. For example, the two coatings 7, 8 may be made or designed differently in terms of at least one of the following parameters: Porosity of the coating 7, 8, surface roughness of the coating 7, 8, layer thickness 9, 10, coefficient of thermal expansion as well as heat emission coefficient. It is possible as a result to optimally adapt the respective coating 7, 8 to different requirements. For example, the inner coating 7 must be specially adapted to the corrosive exhaust gases. It must be able to withstand the high exhaust gas temperatures and shall generate the lowest wall friction possible for the exhaust gas flow 3 in order to achieve the lowest possible flow resistance within the tubular body 1. Contrary to this, the outer coating 8 must be able to withstand the comparatively corrosive ambient conditions of an exhaust system 2. Depending on the design, it may also be necessary for the outer coating 8 to make possible the most favorable heat transmission possible from the tubular body 1 to the air arriving at the tubular body 1 from the outside even at low velocities of air.

In addition or as an alternative to the different coatings 7, 8, it is possible, in addition, to provide at least one of the coatings 7, 8 with a varying parameter in its thickness direction 12 indicated by an arrow in FIGS. 1 through 4. In addition or as an alternative, the respective coating 7, 8 may have at least one varying parameter in a longitudinal direction 13 of the tubular body 1, which direction is indicated by a double arrow. In addition or as an alternative, the respective coating 7, 8 may have at least one varying parameter in a circumferential direction 14 indicated by a double arrow. For example, the emissivity, i.e., the heat emission coefficient, may vary in the longitudinal direction 13. For example, the coefficient of thermal expansion may vary in the circumferential direction 14, for example, in a bent tubular body 1. It is likewise possible to vary the porosity in the thickness direction 12.

Parameters that can be varied within the respective coating 7, 8 in the thickness direction 12 and/or in the longitudinal direction 13 and/or in the circumferential direction 14 are especially the porosity, roughness, layer thickness, coefficient of thermal expansion, and heat emission coefficient, and any desired combinations of such parameters are conceivable as well. The variation of at least one parameter within the respective coating 7, 8 in the thickness direction 12 and/or in the longitudinal direction 13 and/or in the circumferential direction 14 can now be embodied regardless of whether two coatings 7, 8 are provided or only one inner coating 7 or only the outer coating 8 is provided.

According to another, especially advantageous embodiment, which can be embodied facultatively or cumulatively to one of the above embodiments, at least one of the coatings 7, 8 may be provided with a temperature-dependent heat emission coefficient. In other words, the heat emission coefficient of the respective coating 7, 8 changes with the temperature. Provisions may be preferably made for the heat emission coefficient to be lower below a first temperature T1 than above a second temperature T2. The second temperature T2 may be higher than the first temperature T1: T2>T1. It may also be theoretically possible to select the two temperatures T1, T2 such that they are approximately equal: T1=T2, as a result of which it would be possible to achieve an abrupt change in emissivity. For example, provisions may be made for selecting the first temperature T1 to be about 600° C. and for setting the second temperature at about 700° C. It is now possible concerning the heat emission coefficient to embody the tubular body 1 by means of the respective coating 7, 8 such that it has a comparatively low emissivity up to a temperature of about 600° C., as a result of which the respective coating 7, 8 has a comparatively high heat insulating effect. This may be advantageous for maintaining a predetermined operating temperature during phases of operation of the internal combustion engine during which the exhaust gases removed carry only a comparatively small amount of heat. For example, correct function can be achieved hereby for an oxidation-type catalytic converter or an SCR catalytic converter or an NOₓ storage catalyst. However, if the internal combustion engine is operating in operating states, e.g., at full load, in which a comparatively large amount of heat is contained in the exhaust gas, overheating of certain components may easily occur in case of such an efficient heat insulation. The suggestion proposed here counteracts this, because the emissivity is made markedly higher above the second temperature T2, so that the tubular body 1 can remove a considerably larger amount of heat to the outside and especially remove it by radiation. An overheating protection can be more or less achieved hereby by means of a heat insulation operating in a temperature-dependent manner. This is possible by a corresponding design of the respective coating 7, 8.

A gradual change in emissivity may take place between the temperatures T1, T2. The emissivity may change gradually below T1 and above T2, so that there is, in particular, a proportional relationship between the temperature and the emissivity.

FIGS. 1 and 2 show an embodiment in which the respective coating 7, 8 preferably has approximately the same coefficient of thermal expansion as the tubular body 1 or as the wall 4 of the tubular body 1. As a consequence, the coatings 7, 8 can uniformly follow an expansion as well as a shrinkage of the wall 4 without thermal stresses developing between the wall 4 and the respective coating 7, 8. The bonding of the respective coating 7, 8 to the wall 4 is correspondingly stressed only comparatively slightly, so that a comparatively long service life is obtained for the coating 7, 8 on the tubular body 1 or on the wall 4.

Contrary to this, FIGS. 3 through 5 show an embodiment in which the respective coating 7, 8 has a lower coefficient of thermal expansion than the material of the tubular body 1 or the wall 4. In such an embodiment, the respective coating 7, 8 has a microstructure 15. Both coatings 7, 8 are provided with such a microstructure 15 in the example according to FIGS. 3 through 5. Also conceivable is, in principle, an embodiment that has only the inner coating 7 or only the outer coating 8, which coating is then provided with the respective microstructure 15. An embodiment is also conceivable in which both the inner coating 7 and the outer coating 8 are present, but only one of the two coatings 7, 8 has a lower coefficient of thermal expansion than the tubular body 1 and is provided with the microstructure 15.

The respective microstructure 15 is characterized especially in that the coating 7, 8 provided with the microstructure 15 comprises a plurality of individual coating sections 16. The individual coating sections 16 are each firmly connected to the tubular body 1 or to the wall 4 thereof. However, they are mobile relative to one another with the tubular body 1, because they can follow thermal expansion effects of the tubular body 1.

The respective microstructure 15 may be formed, e.g., by grooves 17 prepared in the surface, wherein the respective groove 17 passes through the respective coating 7, 8 at least partly in the thickness direction 12. The grooves 17 do not pass completely through the coating 7, 8 in the example being shown. Also conceivable is, however, in principle, an embodiment in which the grooves 17 pass completely through the coating 7, 8, so that the groove base is formed now by the respective surface 5, 6 of wall 4. As an alternative to the grooves 17, the microstructure 15 may also be formed by means of cracks 18, which pass through the respective coating 7, 8 at least partly and preferably completely in the thickness direction 12.

The grooves 17 can be prepared by machining, by means of etching techniques or by means of templates. The cracks 18 can be prepared, e.g., by applying the corresponding coating 7, 8 at a comparatively low temperature and subsequently heating the tubular body 1 with the respective coating 7, 8. Cracking occurs due to the thermal expansion of the tubular body 1 because of the correspondingly low coefficient of thermal expansion of the respective coating 7, 8. To make it possible to form the cracks 8 in a predetermined manner, it is possible, in particular, to engrave the coating 7, 8 in the desired manner, so that the cracking will then take place along the engraving. Especially advantageous is an embodiment in which the microstructure 15 is designed such that the grooves 17 or cracks 18 are closed completely or essentially completely below a predetermined temperature. This can be embodied in an especially simple manner in the aforementioned procedure for preparing the cracks 18.

By providing the respective coating 7, 8 with the microstructure 15, it is possible, in particular, to make at least one parameter of the coating 7, 8 temperature-dependent. For example, the heat-insulating effect of the respective coating 7, 8 can be provided with a marked temperature dependence by means of the microstructure 15. The grooves 17 or cracks 18 are comparatively small and especially closed at a low temperature, as a result of which the respective coating 7, 8 has a comparatively high effectiveness in terms of its heat-insulating effect. The tubular body 1 expands more greatly with rising temperature than the respective coating 7, 8, as a result of which the coating sections 16 will move relative to one another, on the one hand, and, on the other hand, the grooves 17 or cracks 18 become larger. The heat-insulating effect of the respective coating 7, 8 becomes worse hereby. The tubular body 1 can consequently transmit more heat to the environment and especially radiate it into the environment as the temperature rises. It is thus likewise possible by means of this design to achieve a certain overheating protection.

The various embodiments described above can be combined with one another, insofar as meaningful, quasi as desired.

The tubular body 1 may be, for example, a tube for feeding exhaust gas to an exhaust gas-treating means or for removing exhaust gas from an exhaust gas-treating means. The tubular body 1 may also be a tube within an exhaust gas-treating means. Furthermore, the tubular body 1 may be a housing or a housing section, e.g., a funnel or a jacket, of an exhaust gas-treating means. Furthermore, the tubular body 1 may be a tube or a duct of an exhaust gas heat exchanger or of an exhaust gas recirculating heat exchanger. The present invention thus also pertains to an exhaust gas-treating means for an exhaust system 2 of an internal combustion engine, especially of a motor vehicle, which contains or has at least one such tubular body 1, doing so especially in the form of a tube or a housing or a housing section. The present invention also pertains, furthermore, to a heat exchanger, especially for an exhaust system 2 of an internal combustion engine, preferably of a motor vehicle, in which at least one tube is formed by such a tubular body 1.

While specific embodiments of the invention have been described in detail to illustrate the application of the principles of the invention, it will be understood that the invention may be embodied otherwise without departing from such principles.

What is claimed is:

1. An exhaust gas carrying tubular body for an exhaust system of an internal combustion engine, the tubular body comprising:
a tube wall forming the tubular body, the tube wall having an inner surface provided on a tubular body inside facing the exhaust gas and an outer surface provided on a tubular body outside facing away from the exhaust gas; and
a coating on one of the inner surface and the outer surface, the coating consisting of a composite ceramic based on nanoparticles.

2. A tubular body in accordance with claim 1, wherein:
the coating is thinner than a wall thickness of the tube wall of the tubular body; and
the coating has a layer thickness in a range of 1/100 to 1/10 of the wall thickness.

3. A tubular body in accordance with claim 1, further comprising another coating on the other of the inner surface and the outer surface to provide an inner coating and an outer coating, the another coating consisting of a composite ceramic based on nanoparticles wherein:
the inner coating is made different in terms of at least one parameter from the outer coating; and
the at least one parameters being one of porosity, surface roughness, layer thickness, coefficient of thermal expansion, heat emission coefficient, modulus of elasticity, tensile strength, and compressive strength.

4. A tubular body in accordance with claim 1, wherein:
the coating has at least one varying parameter in a thickness direction and/or in a longitudinal direction of the tubular body and/or in the circumferential direction of the tubular body; and
the varying parameter is one of porosity, roughness, layer thickness, coefficient of thermal expansion, heat emission coefficient, modulus of elasticity, tensile strength, and compressive strength.

5. A tubular body in accordance with claim 1, wherein:
the coating is provided with a temperature-dependent coefficient of thermal expansion; and
the coefficient of thermal expansion is more below a first temperature than the coefficient of thermal expansion is above a second temperature, the second temperature being either equal to the first temperature or higher than the first temperature.

6. A tubular body in accordance with claim 1, wherein the coating has the same coefficient of thermal expansion as the tubular body.

7. A tubular body in accordance with claim 1, wherein:
the coating has a lower coefficient of thermal expansion than the tubular body; and
the coating has a microstructure with the coating comprising a plurality of individual coating sections, which are each firmly connected to the tubular body but are mobile relative to one another with the tubular body.

8. A tubular body in accordance with claim 7, wherein:
the microstructure is formed by cracks and/or grooves, which pass at least partly through the respective coating in a thickness direction; and
the cracks and/or grooves are closed below a predetermined temperature.

9. A tubular body in accordance with claim 1, wherein the tubular body is at least one of the following components:
a tube for feeding exhaust gas to an exhaust gas-treating device;
a tube for removing exhaust gas from an exhaust gas-treating device;
a tube within an exhaust gas-treating device;
a housing or a housing section forming any of a funnel, a jacket, an exhaust gas-treating device; and
a tube or a duct of a heat exchanger, an exhaust gas heat exchanger or of an exhaust gas recirculating heat exchanger.

10. An exhaust system of a motor vehicle internal combustion engine, the system comprising
a motor vehicle with body for an exhaust system of an internal combustion engine, the exhaust system comprising:
at least one tubular body through which exhaust gas flows, the tubular body having a tube wall with an inner surface facing the exhaust gas and an outer surface facing away from the exhaust gas; and
a coating on one of the inner surface and the outer surface, the coating consisting of a composite ceramic based on nanoparticles.

11. An exhaust system in accordance with claim 10, wherein
the coating is thinner than a wall thickness of the tube wall of the tubular body; and
the coating has a layer thickness in a range of 1/100 to 1/10 of the wall thickness.

12. An exhaust system in accordance with claim 10, further comprising another coating on the other of the inner surface and the outer surface to provide an inner coating and an outer coating, the another coating consisting of a composite ceramic based on nanoparticles wherein:
the inner coating is made different in terms of at least one parameter from the outer coating; and
the at least one parameters being one of porosity, surface roughness, layer thickness, coefficient of thermal expansion, heat emission coefficient, modulus of elasticity, tensile strength, and compressive strength.

13. An exhaust system in accordance with claim 10, wherein
the coating has at least one varying parameter in a thickness direction and/or in a longitudinal direction of the tubular body and/or in the circumferential direction of the tubular body; and
wherein the varying parameter is one of porosity, roughness, layer thickness, coefficient of thermal expansion, heat emission coefficient, modulus of elasticity, tensile strength, and compressive strength.

14. An exhaust system in accordance with claim 10, wherein:
the coating is provided with a temperature-dependent coefficient of thermal expansion; and
the coefficient of thermal expansion is more below a first temperature than coefficient of thermal expansion is above a second temperature, the second temperature being either equal to the first temperature higher than the first temperature.

15. An exhaust system in accordance with claim 10, wherein coating has the same coefficient of thermal expansion as the tubular body.

16. An exhaust system in accordance with claim 10, wherein:
the coating has a lower coefficient of thermal expansion than the tubular body; and
the coating has a microstructure with the coating comprising a plurality of individual coating sections, which are each firmly connected to the tubular body but are mobile relative to one another with the tubular body.

17. An exhaust system in accordance with claim 16, wherein:
the microstructure is formed by cracks and/or grooves, which pass at least partly through the respective coating in a thickness direction; and
the cracks and/or grooves are closed below a predetermined temperature.

18. An exhaust system in accordance with claim 10, wherein the tubular body is at least one of the following components:
a tube for feeding exhaust gas to an exhaust gas-treating device;
a tube for removing exhaust gas from an exhaust gas-treating device;
a tube within an exhaust gas-treating device;
a housing or a housing section forming any of a funnel, a jacket, an exhaust gas-treating device; and
a tube or a duct of a heat exchanger, an exhaust gas heat exchanger or of an exhaust gas recirculating heat exchanger.

19. An exhaust gas carrying tubular body for an exhaust system of an internal combustion engine, the tubular body comprising:
a tube wall having an inner surface provided on a tubular body inside facing the exhaust gas and an outer surface provided on a tubular body outside facing away from the exhaust gas; and
a coating on one of the inner surface and the outer surface, the coating comprising a composite ceramic formed of nanoparticles.

20. A tubular body in accordance with claim 19, wherein the coating has a temperature-dependent heat emission coefficient.
